(19) United States
(12) Patent Application Publication
(10) Pub. No.: US 2009/0031396 A1
(43) Pub. Date: Jan. 29, 2009

(54) METHOD OF AND APPARATUS FOR MANAGING ACCESS PRIVILEGES IN CLDC OSGi ENVIRONMENT

(75) Inventors: Dong-shin JUNG, Suwon-si (KR); Subramanian Krishnamoorthy, Bangalore (IN); Lohith Vrushabendrappa, Bangalore (IN); Vanraj Vala, Bangalore (IN); Vinoth Sasidharan, Bangalore (IN)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/179,123

(22) Filed: Jul. 24, 2008

(30) Foreign Application Priority Data
Jul. 24, 2007 (IN) 1597/CHE/2007
Mar. 18, 2008 (KR) 10-2008-0024875

(51) Int. Cl. G06F 21/00

(52) U.S. Cl. 726/1

(57) ABSTRACT

Provided are a method and apparatus for managing resource access privileges of an application in a Connected Limited Device Configuration (CLDC) Open Service Gateway Initiative (OSGi) environment. The method includes executing the application in a thread having a unique thread identifier, identifying the application by mapping the unique thread identifier with an application identifier from a mapping table, examining a security policy to determine the kind of resource access privileges the identified application has, and allowing or not allowing, according to the examination result, the application to access the resources. Accordingly, when an application tries to access resources in a device, access privileges of the application can be managed so that the application does not maliciously access the resources.

### CROSS-REFERENCE TO RELATED PATENT APPLICATION

This application claims priority from Indian Patent Application No. 1597/CHE/2007, filed on Jul. 24, 2007 in the Indian Intellectual Property Office, and Korean Patent Application No. 10-2008-0024875, filed on Mar. 18, 2008 in the Korean Intellectual Property Office, the disclosures of which are incorporated herein in their entirety by reference.

### BACKGROUND OF THE INVENTION

1. Field of the Invention

Methods and apparatuses consistent with the present invention relate to a framework for actively installing applications, and more particularly, to managing resource access privileges of an application in a Connected Limited Device Configuration (CLDC) Open Service Gateway initiative (OSGi) environment.

2. Description of the Related Art

Most terminal devices and embedded devices include a Java programming language platform in order to execute Java applications, which can be preinstalled or downloaded. One of such platforms is Java 2 Platform, Micro Edition (J2ME). J2ME architecture has been especially designed for embedded systems having limited resources, such as mobile phones, beepers, personal digital assistants (PDAs), smart cards, and set-top boxes.

However, since there are big functional and performance differences between these devices, the J2ME architecture has been designed by separating the configuration from the profile thereof, in order to use the J2ME platform in a plurality of device categories. The pair formed by the configuration and profile defines a minimum set of application program interfaces (APIs) or APIs that a device must support. An advantage of this concept is that, even if an application is produced using any one of the defined APIs, the application can be operated on the J2ME platform. In general, the set of APIs can be extended using optional libraries, if necessary, e.g., in a case where a user wants to add an API to a program.

Two representative configurations related to J2ME are the CLDC and the Connected Device Configuration (CDC). Platforms formed with Mobile Information Device Profile (MIDP) and CLDC are designed for central processing units (CPUs) having a relatively limited performance compared to CDC or memory-limited systems, and standard Java platforms use APIs and application virtual machine (VM) technology.

### SUMMARY OF THE INVENTION

The present invention provides a method of and apparatus for managing access privileges of an application in order to overcome the limitation that only one application can be executed in one VM once in an execution environment of driving applications using VMs and solve a problem where applications can maliciously access resources in a framework.

According to an aspect of the present invention, there is provided a method of managing access privileges of an application, the method comprising: executing the application in a thread having a unique thread identifier; identifying the application by mapping the unique thread identifier with an application identifier from a mapping table; examining a security policy to determine the kind of resource access privileges the identified application has; and allowing or not allowing, according to the examination result, the application to access the resources.

According to another aspect of the present invention, there is provided a computer readable recording medium storing a computer readable program for executing the method.

According to another aspect of the present invention, there is provided an apparatus for managing access privileges of an application, the apparatus comprising: a thread generator generating a thread having a unique thread identifier to execute the application; an identifying unit identifying the application by mapping the unique thread identifier with an application identifier from a mapping table; and an examination unit examining a security policy to determine the kind of resource access privileges the identified application has and allowing or not allowing, according to the examination result, the application to access the resources.

### BRIEF DESCRIPTION OF THE DRAWINGS

The above and other aspects of the present invention will become more apparent by describing in detail exemplary embodiments thereof with reference to the attached drawings in which:

FIG. 1A illustrates an architecture of a CLDC MIDP platform;

FIG. 1B illustrates an architecture of a CLDC OSGi device;

FIG. 2 illustrates an architecture of a system for managing resource access privileges of an application in a CLDC OSGi environment;

FIG. 3A is a block diagram of a CLDC OSGi framework security architecture according to an exemplary embodiment of the present invention;

FIG. 3B illustrates an example where a sub-task generated by an application is mapped to a thread in the security architecture illustrated in FIG. 3A;

FIG. 4 is a block diagram of an apparatus for managing privileges of an application trying to access resources of a device according to an exemplary embodiment of the present invention; and

FIG. 5 is a flowchart illustrating a method of managing privileges of an application trying to access resources of a device according to an exemplary embodiment of the present invention.

### DETAILED DESCRIPTION OF EXEMPLARY EMBODIMENTS OF THE INVENTION

The present invention will be described in detail by explaining exemplary embodiments of the invention with reference to the attached drawings.

In the exemplary embodiments described below, a framework denotes an execution environment in which an application is driven by using a VM.

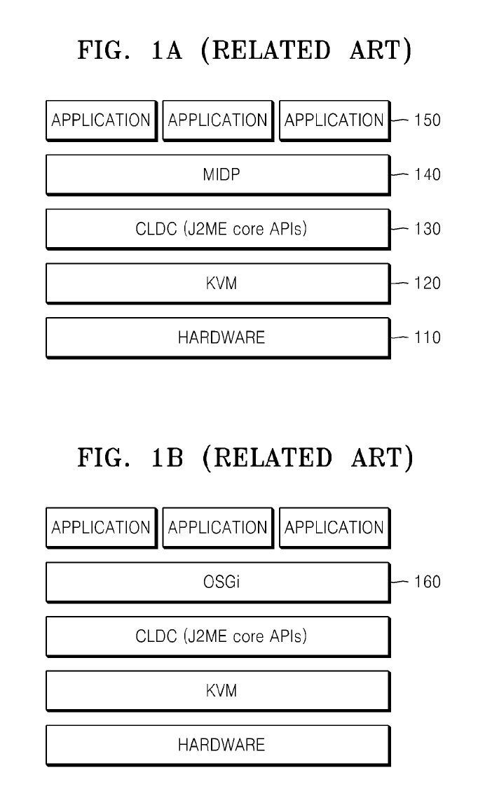

FIG. 1A illustrates an architecture of a related art CLDC MIDP platform, which includes hardware 110, a VM 120, a CLDC 130, an MIDP 140, and applications 150. The VM 120 denotes software for executing an application independently from a platform on the hardware 110. A K virtual machine (KVM) can be used for the VM 120 in a CLDC-MIDP environment. The KVM is a type of platform-independent VM for driving the CLDC 130 (including core APIs of J2ME) and the MIDP 140.

FIG. 1A illustrates CLDC-MIDP as the pair of configuration and profile described above. The CLDC 130 defines a library set which is reduced as compared to the VM and Java language specification. The CLDC 130 is made for embedded devices (e.g., middle-low performance mobile phones) having limited resources. The MIDP 140 defines a simple model for application programming including an application model, a user interface (e.g., a text box and form), and networking. In the CLDC-MIDP environment described above, the applications 150 are loaded on the uppermost of the CLDC-MIDP platform and executed.

However, problems exist in that the CLDC-MIDP platform does not have robust spare resources and is quite different from standard Java platforms in supported API documents and application VM technology. In addition, in conventional Java frameworks, only one Java application can be executed in one VM once. Thus, in order to execute a plurality of applications, a plurality of VMs must be inefficiently driven on hardware.

One method of addressing the disadvantages of the combination of MIDP and CLDC described above is an OSGi including an application framework having greater performance than the CLDC-MIDP platform.

FIG. 1B illustrates an architecture of a related art CLDC OSGi device, which has an architecture similar to that illustrated in FIG. 1A but uses OSGi technology. An OSGi 160 is a type of a middle framework operating independently from an operating system (OS) or a service platform, and is a system environment in which applications can be actively installed and deleted using Java. Technically, the OSGi 160 is an execution environment in which a general and service-oriented framework is described and is a core set of a service interface for potentially transmitting a plurality of values, and service implementation from other providers is added to the core set.

In other words, the OSGi 160 provides a secured and managed general-purpose Java framework supporting extended batches and service applications called bundles that can be downloaded from other providers. The OSGi 160 provides a service by installing a bundle, which is physical binding of a jar file type including a Java class file, wherein the bundle forms a fundamental unit of service distribution and management. Thus, OSGi compatible devices download and install an OSGi bundle, and when the OSGi bundle is no longer necessary in each OSGi compatible device, the OSGi bundle can be removed. An OSGi bundle can register services shared with other bundles under the control of the OSGi 160, and since the OSGi 160 has a service registry, the OSGi 160 performs registration, inquiry, execution, and deletion of each service.

The OSGi 160 can be executed on the uppermost layer of the CLDC 130 and a foundation profile. Furthermore, in the OSGi 160, a plurality of bundles can be executed on one VM. In other words, the OSGi 160 does not have to load or execute as many VMs as the number of Java applications. Once a VM is loaded, a plurality of bundles can be executed on the VM, and thus, the required memory resources are dramatically reduced. Based on the robustness of the OSGi 160, Java specification request (JSR) 232 suggested that OSGi be used as a fundamental application framework for mobile devices.

However, the OSGi 160 implemented on the CLDC 130 has a significant disadvantage regarding application security. This disadvantage is caused by the fact that the CLDC 130 does not basically provide any fundamental support about full Java 2 security on which the entire OSGi security design depends. In addition, there is no mechanism or method of managing access privileges for coding in an application executed in a CLDC-OSGi environment.

Thus, the present invention overcomes the above-described disadvantages by providing a method of preventing applications executed in a CLDC-OSGi environment from maliciously accessing other services or applications of OSGi.

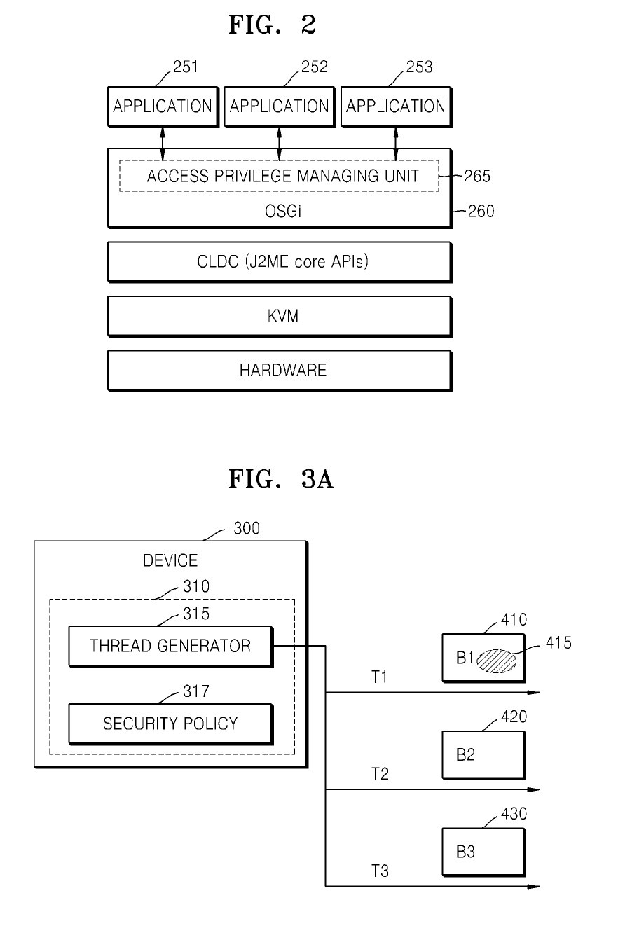

FIG. 2 illustrates an architecture of a system for managing resource access privileges of an application in a CLDC-OSGi environment, which has a configuration similar to that of FIG. 1B. In FIG. 2, an OSGi 260 further includes a unit (e.g., access privilege managing unit 265) managing access requests of applications 251, 252, and 253.

For example, if there is no adequate authentication or security means when the application 251 tries to uses resources by accessing another application 252 or 253 or a specific service in the OSGi 260, a framework can be exposed in a defenseless state against a malicious resource request from the outside. Thus, various exemplary embodiments of the present invention provide an access privilege managing unit 265 managing resource requests and allowing access of only authorized requests.

In the exemplary embodiments of the present invention described below, although a framework is described with respect to a CLDC-OSGi environment, those of ordinary skill in the art can easily apply to present invention to other execution environments.

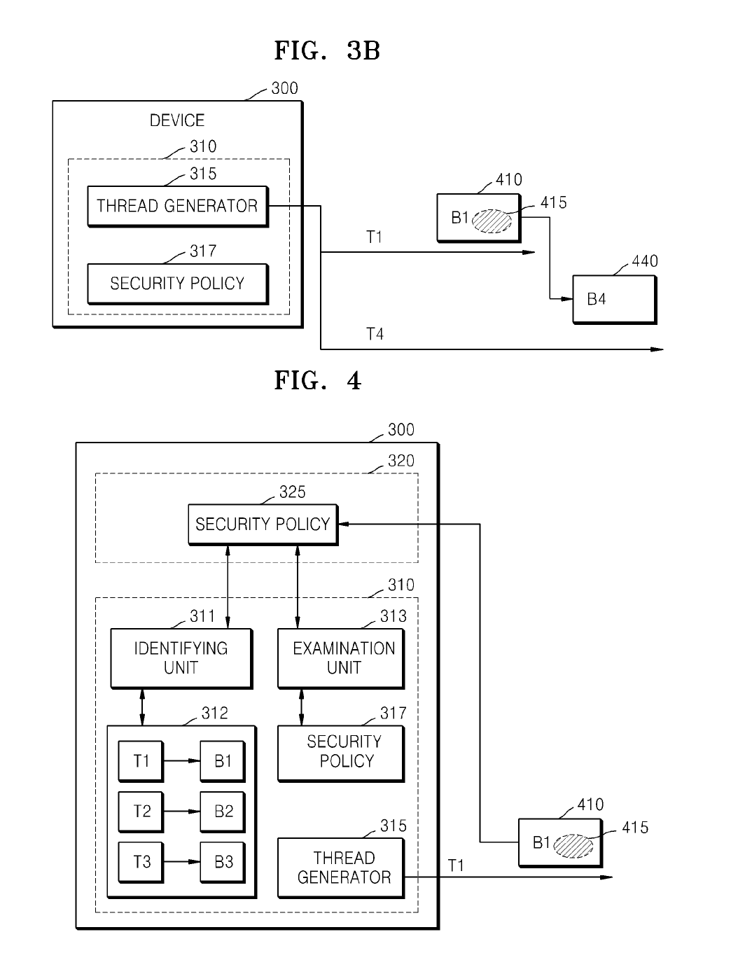

FIG. 3A is a block diagram of a CLDC OSGi framework security architecture according to an exemplary embodiment of the present invention, which includes a device 300 and applications 410, 420, and 430 (bundles installed in the device 300).

The device 300 includes a privilege managing unit 310 managing resource request privileges of the applications 410, 420, and 430, wherein the privilege managing unit 310 includes a thread generator 315 and a security policy 317.

The thread generator 315 manages threads T1, T2, and T3 generated to execute the newly installed applications 410, 420, and 430. The applications 410, 420, and 430 are respectively executed on the generated threads T1, T2, and T3. The threads T1, T2, and T3 are generated on an application basis and may be custom threads designed to meet characteristics of the framework 300.

If such an application tries to access a specific resource (another application or service) of the device 300, the application must have access privilege. For example, in FIG. 3A, since the application B1 410 has an access privilege set 415, the application B1 410 is allowed to access the specific resource. However, since the application B2 420 or the application B3 430 does not have an access privilege set, the application B2 420 or the application B3 430 is not allowed to access the resources.

The security policy 317 manages the policy to determine the kind of resource that each of the applications 410, 420, and 430 can access and use. The security policy 317 can be recorded in a specific file or database (DB).

FIG. 3B illustrates that a sub-task generated by an application is mapped to a thread in the security architecture illustrated in FIG. 3A, wherein a sub-task B4 440 is generated by the application B1 410.

Like other applications, a thread T4 is generated by the thread generator 315 and allocated to the sub-task B4 440. The sub-task B4 440 can be executed on the allocated thread T4.

If the thread T4 on which the sub-task B4 440 is executed tries to access services or other applications of the device 300, an exceptional status may occur in that the thread T4 cannot use standard communication specifications of the device 300. In order to prevent this possibility, an application developer may use a customized thread API for replacing a Java 2 Platform, Standard Edition (J2SE) standard thread API in order to execute a sub-task generated by an application.

A method of allocating a thread to each application installed in a device in order to execute the application has been described. These threads accept examination of resource access privileges according to security policy included in the framework.

Hereinafter, a security architecture driving model for examining the privilege of a thread trying to access resources of such a device will be described.

FIG. 4 is a block diagram of an apparatus for managing privileges of an application trying to access resources of a device according to an exemplary embodiment of the present invention. The apparatus 300 includes the privilege managing unit 310 described in FIGS. 3A and 3B and a service registry 320. The privilege managing unit 310 includes an identifying unit 311, a mapping table 312, an examination unit 313, a thread generator 315, and a security policy 317.

The service registry 320 is a managing member for registering, inquiring, executing, and deleting services provided by the device 300. FIG. 4 illustrates that a single service 325 is registered.

The thread generator 315 generates the thread T1 for executing the application B1 410 as described above. The thread T1 has a unique thread identifier different from that of any other thread. In addition, as described above, an application developer may use a customized thread API for replacing a J2SE standard thread API in order to execute a sub-task generated by an application. The customized thread API guarantees that a generated custom thread can have a unique thread identifier, which can be mapped to an application generating the custom thread in a mapping table.

In addition, the suggested security model can be designed so that a thread identifier and an application identifier are allocated only once and are not replaced or changed until a bundle is ruined or removed. Through this manner, the suggested security model can better prevent hacking attempts.

The mapping table 312 stores a thread identifier and an identifier of a corresponding application as a pair. It can be known from the mapping table 312 which thread is allocated to a certain application. FIG. 4 illustrates the mapping table 312 showing that the thread T1 corresponds to the application B1 410.

The identifying unit 311 identifies an application by mapping a unique thread identifier with an application identifier from the mapping table 312. For example, when the application B1 410 requests to access the service 325, the identifying unit 311 accesses the mapping table 312 by using the thread identifier of the thread T1 carrying the request. As a result of the access, it can be identified that an application corresponding to the thread T1 is the application B1 410.

The examination unit 313 examines the security policy 317 to determine the kind of resource access privileges the identified application has. As a result of the examination, if the identified application has a resource access privilege, the examination unit 313 allows the identified application to access resources, and if not, the examiner 313 rejects the identified application to access the resources. For example, when the application B1 410 inquires about the security policy 317 through the examination unit 313, if the application B1 410 has an access privilege to the service 325 as a result of the inquiry, the access privilege set 415 is granted to the application B1 410.

The apparatus for managing privileges of an application trying to access resources of a device has been described with reference to the exemplary embodiment illustrated in FIG. 4. According to the current exemplary embodiment, by identifying an application using a mapping table and examining the security policy of the identified application, access privileges of applications can be managed so that the applications cannot maliciously access the resources of a device. In addition, when the illustrated device is used in a CLDC OSGi environment, since a plurality of applications can be executed in one VM, the required memory resources are dramatically reduced.

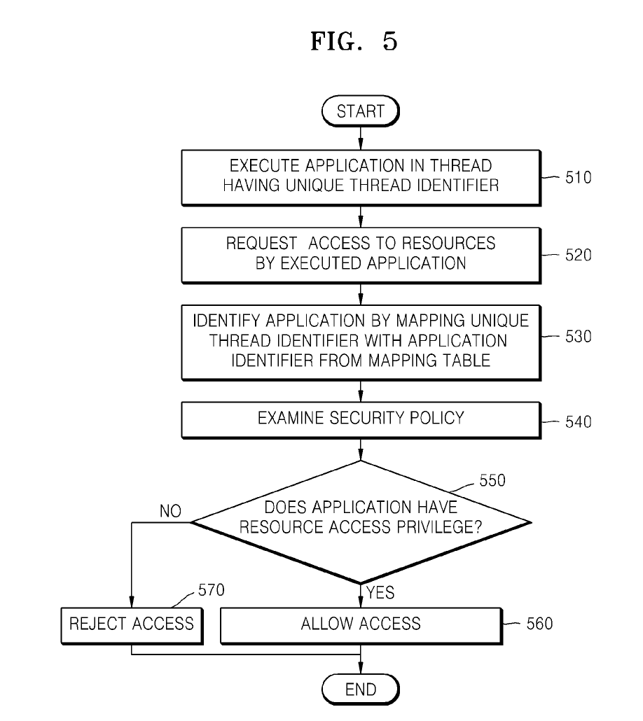

FIG. 5 is a flowchart illustrating a method of managing privileges of an application trying to access resources of a device according to an exemplary embodiment of the present invention.

Referring to FIG. 5, in operation 510, an application is executed in a thread having a unique thread identifier. For example, when an OSGi application is installed in a CLDC OSGi environment, the OSGi application is executed in a custom thread generated by a thread generator.

The custom thread has a unique thread identifier distinguishable from other threads.

In operation 520, the executed application requests access to resources. The resources denote a service or another application in the device.

In operation 530, the application is identified by mapping the unique thread identifier with an application identifier from a mapping table.

In operation 540, if the application requesting resources is identified in operation 530, a security policy is examined to determine the kind of access privileges the application has. A privilege managing unit (310 of FIG. 4), in particular, an examination unit (313 of FIG. 4), determines an access privilege of the application by comparing the access request to the security policy (317 of FIG. 4) existing in the CLDC OSGi framework. These access privileges can be previously set and depend on elements such as location and signer. For example, if it was previously agreed that the device grants all resource access privileges to applications of a company A, when an application of which a signer is A requests access to resources, the request can be accepted.

In operation 550, it is determined whether the application has a resource access privilege. As a result of the determination, if the application has the resource access privilege, the application is allowed to access resources in operation 560. If the application does not have the resource access privilege, the application is rejected from accessing the resources in operation 570. When the application is rejected from accessing the resources, an exception that is an error processing method of a Java framework may be thrown.

The method of managing privileges of an application trying to access resources of a device has been described with reference to the exemplary embodiment illustrated in FIG. 5. According to the current exemplary embodiment, access privileges of applications can be managed so that the applications cannot maliciously access resources in a device. In addition, when the illustrated framework is implemented in a CLDC OSGi environment, since a plurality of applications can be executed in one VM, the required memory resources are dramatically reduced.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains. The invention can also be embodied as computer readable codes transmitted via carrier waves (such as data transmission through the Internet).

According to the exemplary embodiments of the present invention, when an application tries to access resources in a device, access privileges of the application can be managed so that the application does not maliciously access the resources by identifying the application using a mapping table and examining a security policy of the identified application. In addition, when the device is used in a CLDC OSGi environment, since a plurality of applications can be executed in one VM, the required memory resources are dramatically reduced.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of managing access privileges of an application trying to access resources in an execution environment in which applications are driven using a virtual machine, the method comprising:
executing the application in a thread having a unique thread identifier;
identifying the application by mapping the unique thread identifier with an application identifier from a mapping table;
examining a security policy to determine a kind of resource access privileges the identified application has; and
allowing or not allowing, according to a result of the examining, the application to access the resources.

2. The method of claim 1, further comprising, if it is determined that the application does not have an access privilege to resources as the result of the examining, generating an exception.

3. The method of claim 1, wherein the mapping table stores application identifiers by matching application identifiers of all applications in the execution environment with unique thread identifiers of threads in which the applications are executed.

4. The method of claim 1, wherein the resources comprise at least one of services and other applications in the execution environment.

5. The method of claim 1, wherein the security policy is previously set or determined according to an attribute of the application.

6. The method of claim 1, wherein the thread identifier and the application identifier are maintained without any change until the application is removed.

7. The method of claim 1, wherein the execution environment is a Connected Limited Device Configuration Open Service Gateway Initiative environment.

8. A computer readable recording medium storing a computer readable program for executing the method of claim 1.

9. An apparatus for managing access privileges of an application trying to access resources in an execution environment in which applications are driven by using a virtual machine, the apparatus comprising:
a thread generator which generates a thread having a unique thread identifier to execute the application;
an identifying unit which identifies the application by mapping the unique thread identifier with an application identifier from a mapping table; and
an examination unit which examines a security policy to determine a kind of resource access privileges the identified application has, and allows or does not allow the application to access the resources according to a result of the examination.

10. The apparatus of claim 9, further comprising an exception generator which generates an exception if the examination unit determines that the application does not have an access privilege to resources as the result of the examination.

11. The apparatus of claim 9, wherein the mapping table stores application identifiers by matching application identifiers of all applications in the execution environment with unique thread identifiers of threads in which the applications are executed.

12. The apparatus of claim 9, wherein the resources comprise at least one of services and other applications in the execution environment.

13. The apparatus of claim 9, wherein the security policy is previously set or determined according to an attribute of the application.

14. The apparatus of claim 9, wherein the thread identifier and the application identifier are maintained without any change until the application is removed.

15. The apparatus of claim 9, wherein the execution environment is a Connected Limited Device Configuration Open Service Gateway Initiative environment.
